(19) United States
(12) Patent Application Publication
(10) Pub. No.: US 2013/0145733 A1
(43) Pub. Date: Jun. 13, 2013

(54) DRAIN VALVE APPARATUS AND AIR SEPARATOR THEREOF

(71) Applicants: Jae Seol CHO, Bongdong-eup (KR); Yeonsik Lim, Daegu (KR)

(72) Inventors: Jae Seol CHO, Bongdong-eup (KR); Yeonsik Lim, Daegu (KR)

(73) Assignees: Taechul Industrial Co., Ltd., Daegu (KR); Hyundai Motor Company, Seoul (KR)

(21) Appl. No.: 13/554,835

(22) Filed: Jul. 20, 2012

(30) Foreign Application Priority Data
Dec. 8, 2011 (KR) 10-2011-0131201

(51) Int. Cl. B01D 46/42

(52) U.S. Cl. 55/295; 55/315.2; 55/428.1

(57) ABSTRACT

A drain valve apparatus and an air separator thereof may include a main body having a upper cover, and a cooling shaft, an oil filter coupled to a lower end of the cooling shaft in a length direction of the cooling shaft, an outer body coupled to the upper cover, and surrounding the main body and the oil filter, a drain body disposed in a lower end of the outer body, and having an interior passage formed in a length direction of the outer body at a upper portion, a drain valve passage formed to communicate with the interior passage, an air inflow passage formed to communicate with the drain valve passage, and an exterior passage formed to communicate with the drain valve passage in a lower portion, and a drain valve inserted into the drain valve passage, adapted to selectively communicate the interior passage with the exterior passage.

### CROSS-REFERENCE TO RELATED APPLICATION

The present application claims priority of Korean Patent Application Number 10-2011-0131201 filed Dec. 8, 2011, the entire contents of which application is incorporated herein for all purposes by this reference.

### BACKGROUND OF INVENTION

1. Field of Invention

The present invention relates to a drain valve apparatus and an air separator thereof, and more particularly, to a drain valve apparatus processing compressed air and an air separator thereof.

2. Description of Related Art

Generally, in a case of a large vehicle such as a commercial vehicle, high-pressure compressed air generated at an air compressor is stored in an air tank. When a brake of the vehicle is operated, the compressed air in the air tank is supplied to an air brake apparatus, and is used as a source of a braking force.

The high pressure compressed air generated at the air compressor is cooled and purified through an air separator and an air dryer, and is supplied to the air tank through a valve. Accordingly, if the driver pushes a brake pedal, the compressed air in the air tank actuates the air brake apparatus so as to actuate the brakes of the vehicle. Generally, since the temperature of the high pressure compressed air generated at the air compressor is high, moisture is generated in the high pressure compressed air by a temperature difference between the high pressure compressed air and an exterior temperature. Also, since oil is supplied to the air compressor so as to efficiently operate the air compressor, the oil is mixed with the compressed air. Accordingly, the air dryer disposed between the air compressor and the air tank removes a foreign material, moisture, and oil from the compressed air, and supplies the purified compressed air to the air tank. At the same time, the air dryer cools the compressed air so as to lower the temperature of the compressed air and reduce generation of the moisture due to the temperature difference.

However, when the high temperature compressed air generated at the air compressor is directly supplied to the air dryer, the temperature of the compressed air cannot be efficiently lowered. In addition, an interior component of the air dryer is deformed by the high temperature of the air dryer, and it is difficult to efficiently remove the foreign material, moisture, and oil included in the compressed air with the air dryer.

Thus, in an effort to improve this, a compressed air processing apparatus further includes an air separator between the air compressor and the air dryer. That is, the air separator cools the high temperature compressed air supplied from the air compressor and supplies the cooled compressed air to the air dryer such that the high temperature compressed air is not directly supplied to the air dryer. Also, the compressed air is cooled again in the air dryer such that the generation of the moisture by the temperature difference can be restrained. Further, the air separator removes the foreign material, the moisture, and the oil from the compressed air, and supplies the purified compressed air to the air dryer. Accordingly, the air separator can increase purification efficiency of the compressed air.

However, while a conventional air separator cools the compressed air, the foreign materials, the moisture, and the oil separated from the compressed air can rise upward according to a movement of the compressed air. In addition, since a port exhausting the separated liquid including the foreign materials is large, utilization of space may be deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a drain valve apparatus and an air separator thereof having advantages of effectively removing and exhausting a foreign material, moisture, and oil from compressed air.

Various aspects of the present invention provide for an air separator that may include a main body having a upper cover, and a cooling shaft extended the upper cover, an oil filter coupled to a lower end of the cooling shaft in a length direction of the cooling shaft, an outer body coupled to the upper cover, and surrounding the main body and the oil filter, a drain body disposed in a lower end of the outer body, and having an interior passage formed in a length direction of the outer body at a upper portion, a drain valve passage formed to communicate with the interior passage, an air inflow passage formed to communicate with the drain valve passage, and an exterior passage formed to communicate with the drain valve passage in a lower portion, and a drain valve inserted into the drain valve passage, adapted to selectively communicate the interior passage with the exterior passage. The drain valve may further include a piston having a first body formed to contact an interior circumference of the drain valve passage and disposed in a direction where the exterior passage is provided, a second body formed to contact an interior circumference of the drain valve passage and disposed in a direction where the air inflow passage is provided, and a connecting member connecting the first body and the second body, and an elastic member connected to the first body, and moving according to a length direction of the drain valve passage.

Various aspects of the present invention provide for a drain valve apparatus for exhausting a separated liquid including pollution materials extracted from air in an air separator cooling and purifying air, which may include a drain body disposed in a lower end of the outer body, and having an interior passage formed in a length direction of the outer body at a upper portion, a drain valve passage formed to communicate with the interior passage, an air inflow passage formed to communicate with the drain valve passage, and an exterior passage formed to communicate with the drain valve passage in a lower portion, and a drain valve inserted into the drain valve passage, adapted to selectively communicate the interior passage with the exterior passage. The drain valve includes a piston having a first body formed to contact an interior circumference of the drain valve passage and disposed in a direction where the exterior passage is provided, a second body formed to contact an interior circumference of the drain valve passage and disposed in a direction where the air inflow passage is provided, a connecting member connecting the first body and the second body, and a guide member extended from the first body and having a blow hole formed at one side, an elastic member connected to the first body, and moving according to a length direction of the drain passage, and a fixed member covering the elastic member and the guide member, and coupled to the drain body.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 and FIG. 2 are schematic diagrams of an exemplary system for processing compressed air according to the present invention.

FIG. 3 is a perspective view of an exemplary air separator according to the present invention.

FIG. 4 is an exploded view of an exemplary air separator according to the present invention.

FIG. 5 is a cross-sectional view of FIG. 3.

FIG. 6 to FIG. 7 are schematic diagrams for showing operation of an exemplary drain exhaust apparatus according to the present invention.

FIG. 8 and FIG. 9 are schematic diagrams for showing air flow in a blow hole of an exemplary drain exhaust apparatus according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

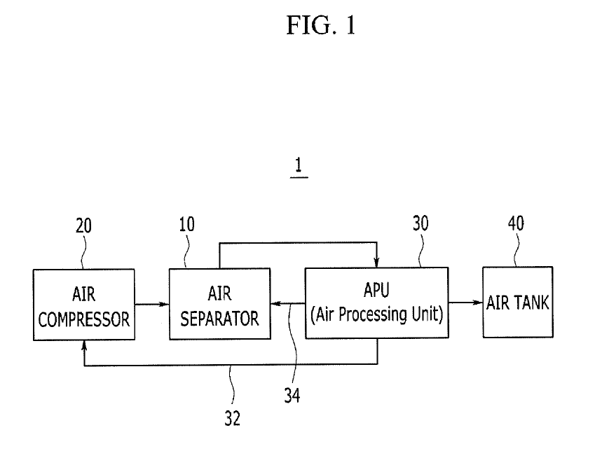

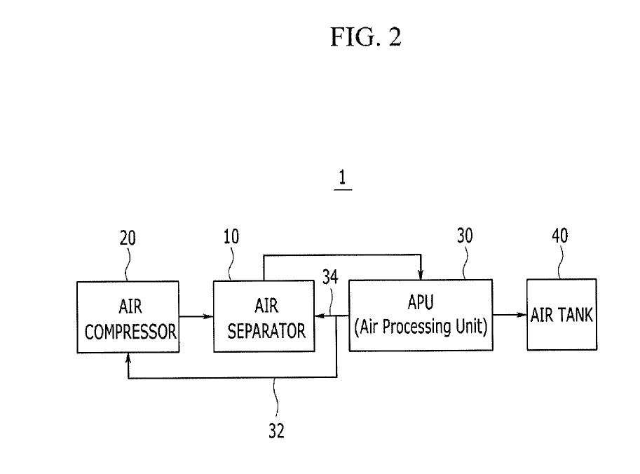

FIG. 1 and FIG. 2 are schematic diagrams of a system for processing compressed air according to various embodiments of the present invention.

Referring to FIG. 1 and FIG. 2, a system 1 for processing a compressed air includes an air compressor 20, an air separator 10, an air processing unit (APU) 30, and an air tank 40.

The system 1 for processing the compressed air cools and purifies the compressed air before the air compressed at the air compressor 20 is stored in the air tank 40.

The compressed air flowing in the air separator 10 is cooled and purified when flowing through an interior screw. The air separator 10 includes a main body 100, an outer body 300, and a drain valve apparatus 400. Details thereof are described later.

The air processing unit (APU) 30 has an air dryer, a governor, and a divergence valve, and dries the compressed air that is cooled and purified at the air separator 10 and stores the compressed air in the air tank 40 through the divergence valve.

When a governor of the air processing unit 30 is operated, the compressed air in the air processing unit 30 is supplied to the air compressor through a bypass pipe 32.

Also, the compressed air in the air processing unit 30 is used to operate a valve of the drain valve apparatus 400 in the air separator 10. Therefore, as shown in FIG. 1, a separate port is formed at the air processing unit 30 such that the compressed air is supplied to the air separator 10 through an air supply pipe 34. Also, as shown in FIG. 2, the compressed air can be supplied to the air separator 10 through the bypass pipe 32 bifurcated from the air supply pipe 34.

The air separator 10 that exhausts a liquid separated from the compressed air using air received from the air supply pipe 34 will be described.

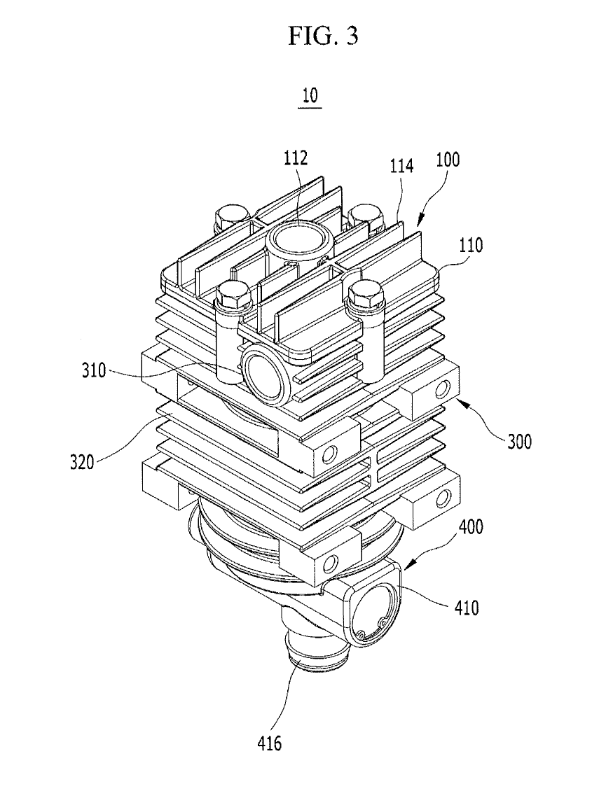

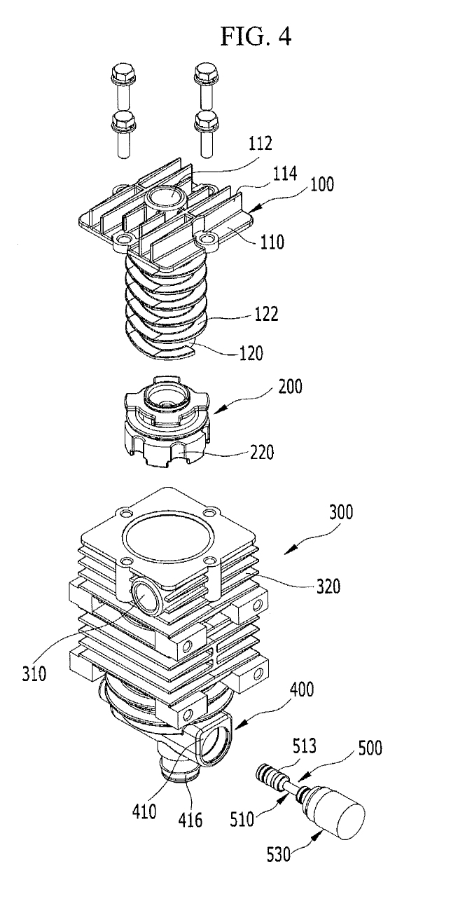

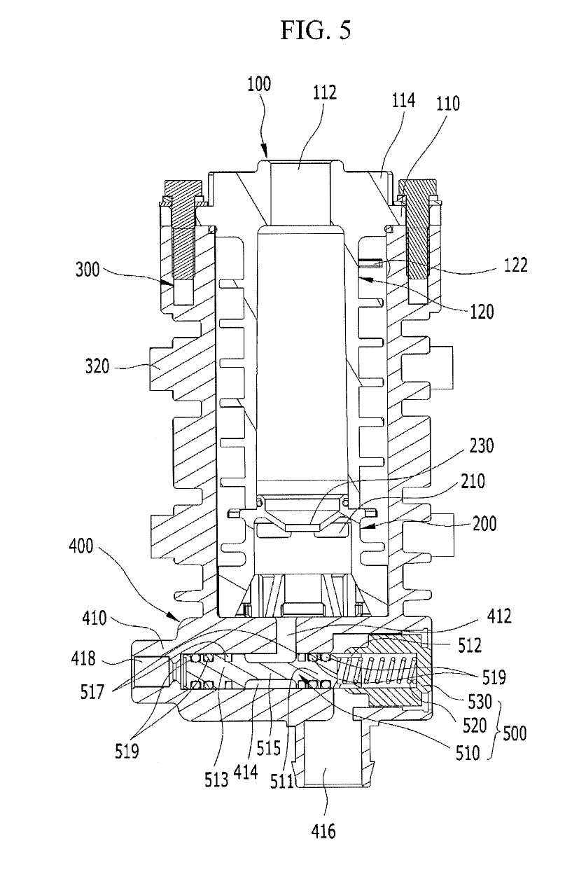

FIG. 3 is a perspective view of an air separator according to various embodiments of the present invention, FIG. 4 is an exploded view an air separator according to various embodiments of the present invention, and FIG. 5 is a cross-sectional view of FIG. 3.

Referring to FIG. 3 to FIG. 5, the air separator includes the main body 100, an oil filter 200, the outer body 300, and the drain valve apparatus 400.

The main body 100 includes an upper cover 110 and a cooling shaft 120. Cooling fins 114 and an air outlet 112 are formed at an upper surface of the upper cover 110. The cooling shaft 120 is extended from the upper cover 110, and a cooling screw is formed at an exterior circumference of the cooling shaft 120. That is, the upper cover 110 and the cooling shaft 120 of the main body 100 are integrally and/or monolithically formed and inserted into the outer body 300.

The oil filter 200 is coupled to a lower end of the cooling shaft 120 in a length direction of the cooling shaft 120. The oil filter 200 includes an exhaust hole 210 formed at an upper portion thereof, a guide way 220 formed at an exterior circumference of a lower portion thereof, and a blocking port 230 having a conical shape and formed at an interior circumference of the upper portion thereof. The guide way 220 guides the separated liquid flowing along the cooling screw 122 of the cooling shaft 120 to a bottom surface of the main body 100. The blocking port 230 blocks the separated liquid from rising with the compressed air in the cooling shaft 120 through the exhaust hole 210.

The outer body 300 has a pipe shape surrounding the main body 100 and the oil filter 200, and an upper surface of the outer body 300 is coupled to the upper cover 110 of the main body 100. That is, the main body 100 is inserted in and coupled to the outer body 300. The compressed air flowing in the air separator flows through a gap between the main body 100 and the outer body 300. An air inlet 310 is formed at one side of the outer body 300, particularly, at an upper portion of the outer body 300. A cooling fin 320 is formed at an exterior circumference of the outer body 300.

The drain valve apparatus includes a drain body 410 and a drain valve 500.

The drain body is disposed in a lower end of the outer body 300 and includes an interior passage 412, a drain valve passage 414, an air inflow passage 418, and an exterior passage 416.

The interior passage is formed in a length direction of the outer body at an upper portion of the drain body 410. The drain valve passage 414 is formed to communicate with the interior passage 412. That is, an angle is formed between the drain valve passage 414 and the interior passage 412. For example, the drain valve passage 414 may be provided to be perpendicular to the interior passage 412. Accordingly, the drain valve passage 414 may be provided along a radial direction of the outer body 300. The air inflow passage 418 is formed to communicate with the drain valve passage 414. The exterior passage 416 is formed to communicate with the drain valve passage 414 at a lower portion of the drain body 410. The interior passage 412 is disposed upwardly from the drain valve passage 414, and the exterior passage 416 is disposed downwardly below the drain valve passage 414. Also, the air inflow passage is disposed at a side of the drain valve passage 414, and particularly, at an end of the drain valve passage 414.

The exterior passage 416 communicates with the drain valve passage 414 apart from the interior passage 412 in a length direction of the drain valve passage 414. That is, the interior passage 412 communicates with the exterior passage 416 through the drain valve passage 414.

The drain valve 500 includes a piston 510, an elastic member 520, and a fixed member 530.

The piston 510 includes a first body 511, a second body 513, and a connecting member 515. The first body 511 and the second body 513 are formed to contact an interior circumference of the drain valve passage. Further, the connecting member 515 connects the first body 511 with the second body 513, and a diameter of the connecting member is smaller than those of the first body and the second body. The first body 511 is disposed in a direction where the exterior passage is disposed, and the second body 513 is disposed in a direction where the air inflow passage 418 is disposed.

The piston 510 further includes a guide member 512 and a blow hole 518.

The guide member is extended from the first body 511, and the blow hole is formed at one side of the guide member 512.

A plurality of scraping rings 517 and a plurality of sealing members 519 are fitted respectively into exterior circumferences of the first body 511 and the second body 513. The scraping ring 517 prevents foreign materials from being attached to an interior circumstance of the drain valve passage 414. The sealing member 519 prevents the separated liquid from leaking through the drain valve passage 414.

The elastic member 520 is coupled to the first body 511 of the piston 510, and a portion of the elastic member 520 is inserted into the guide member 512. The elastic member 520 moves along the length direction of the drain valve passage 414. That is, when force is applied to the elastic member 520, the first body 511 is disposed between the interior passage 412 and the exterior passage 416. Accordingly, the interior passage 412 and the exterior passage 416 do not communicate with each other by the first body 511.

The fixed member 530 is connected to an end of the elastic member 520 that is connected to the first body 511, surrounds the elastic member 520 and the guide member 512, and is coupled to the drain body 410.

Operation of the air separator 10 will now be described in detail.

The air compressed by the air compressor 20 flows into the interior of the outer body 300 through the air inlet 310 of the outer body 300. That is, the compressed air flows into the gap between the main body 100 and the outer body 300. When the compressed air flows downwardly along a cooling screw 122 provided at the cooling shaft 120 of the main body 100, the compressed air is cooled and purified. In further detail, when the compressed air is cooled by heat-exchange with the outside, moisture and oil contained in the compressed air are liquefied and separated with the foreign materials from the compressed air.

The cooled and purified compressed air flows into the interior of the cooling shaft 120 through the exhaust hole 210 of the oil filter 200, and is then exhausted to the air processing unit 30 through the air outlet 112. At this time, the liquid separated from the compressed air can flow into the interior of the cooling shaft 120 with the air flowing into the interior of the cooling shaft 120 through the exhaust hole 210. However, the blocking port 230 of the oil filter 200 can prevent the separated liquid from rising.

Also, the separated liquid, that is, the moisture and the oil separated with the foreign materials when the compressed air passes through the cooling screw 122, is stored in the bottom surface of the main body 100. The exhaust of the separated liquid will be described in detail.

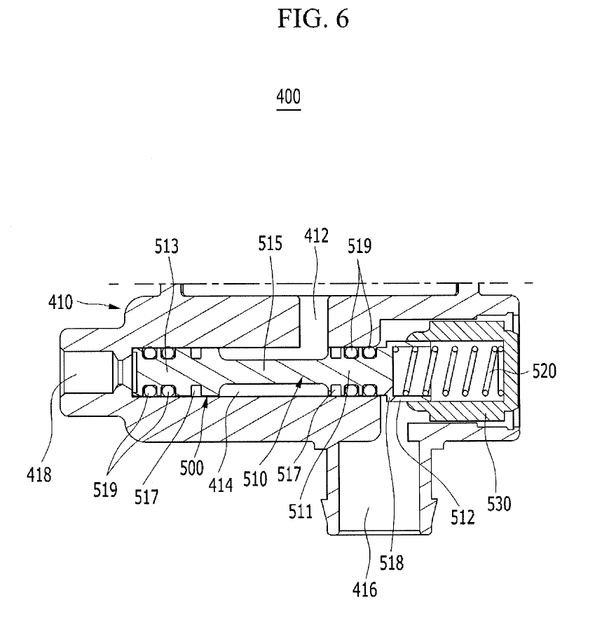

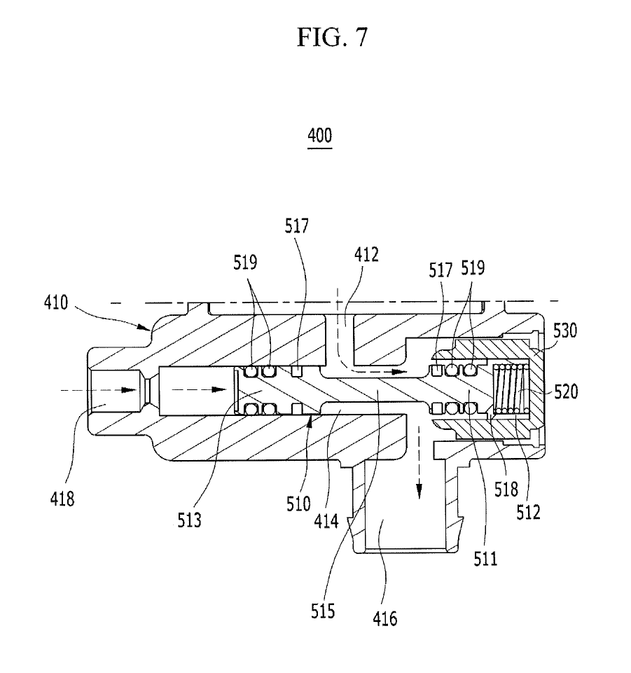

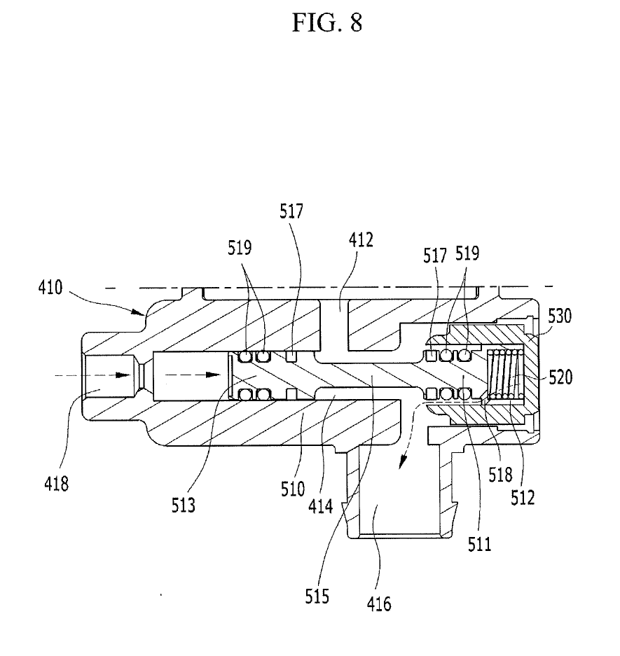

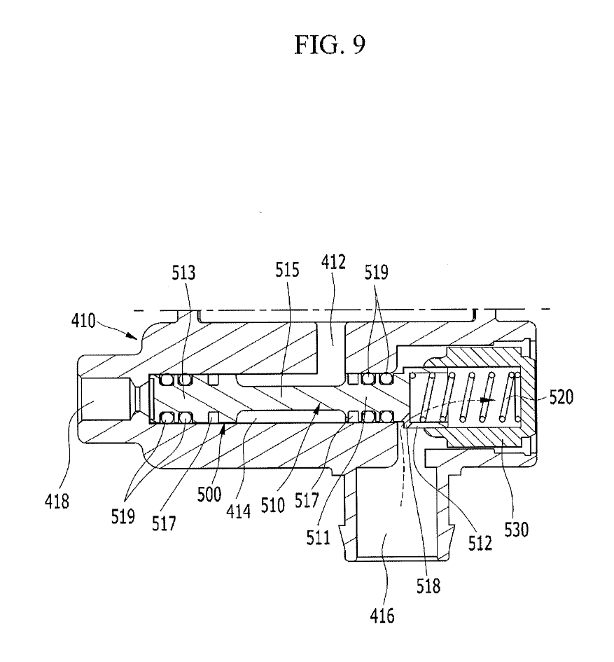

FIG. 6 to FIG. 7 are schematic diagrams for showing operation of a drain exhaust apparatus 400 according to various embodiments of the present invention, and FIG. 8 and FIG. 9 are schematic diagrams for showing air flow in a blow hole 518 of a drain exhaust apparatus 400 according to various embodiments of the present invention.

Referring to FIG. 6 and FIG. 7, when the interior passage 412 and the exterior passage 416 do not communicate with each other because of the first body 511 of the piston 510, the air having flowed through the air inflow passage 418 by the governor of the air processing unit 30 pushes the second body 513 of the piston 510 so as to move the piston 510. At this time, a pressure of the air having flowed through the air inflow passage 418 is higher than elastic force of the elastic member 520. As shown in FIG. 8, when the air having flowed through the air inflow passage 418 pushes the piston 510, air in a space where the elastic member 520 is inserted flows out through the blow hole 518. In addition, as shown in FIG. 9, if the air pushing the piston 510 vanishes, air flows into the space where the elastic member 520 is inserted through the blow hole 518. Therefore, if the piston 510 moves toward the elastic member 520, that is, the first body 511 moves toward the elastic member 520, the interior passage 412 communicates with the exterior passage 416. Accordingly, the separated liquid is exhausted through the exterior passage 416 after passing through the interior passage 412 and the drain valve passage 414.

According to various embodiments of the present invention, foreign materials, moisture, and oil may be effectively removed and exhausted from compressed air.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air separator, comprising:
a main body having an upper cover and a cooling shaft extending from the upper cover;
an oil filter coupled to a lower end of the cooling shaft in a length direction of the cooling shaft;
an outer body coupled to the upper cover and surrounding the main body and the oil filter;
a drain body disposed at a lower end of the outer body, and having an interior passage formed in a length direction of the outer body at an upper portion of the drain body, a drain valve passage formed to communicate with the interior passage, an air inflow passage formed to communicate with the drain valve passage, and an exterior passage formed to communicate with the drain valve passage at a lower portion of the drain body; and
a drain valve inserted in the drain valve passage and adapted to selectively communicate the interior passage with the exterior passage,
wherein the drain valve comprises:
a piston having a first body formed to contact an interior circumference of the drain valve passage and disposed in a direction where the exterior passage is provided, a second body formed to contact an interior circumference of the drain valve passage and disposed in a direction where the air inflow passage is provided, and a connecting member connecting the first body with the second body; and
an elastic member connected to the first body and moving along a length direction of the drain valve passage.

2. The air separator of claim 1, wherein a diameter of the connecting member is smaller than those of the first body and the second body.

3. The air separator of claim 1, wherein the exterior passage communicates with the drain valve passage apart from the interior passage in a length direction of the drain valve passage.

4. The air separator of claim 1, wherein the interior passage is perpendicular to the drain valve passage.

5. The air separator of claim 1, wherein the oil filter further comprises a blocking port formed with a conical shape at an interior of an upper portion thereof.

6. The air separator of claim 1, wherein the oil filter further comprises a plurality of guide ways formed at an exterior circumference of a lower portion in a length direction.

7. The air separator of claim 1, wherein the piston further comprises a plurality of scraping rings fitted respectively in exterior circumferences of the first body and the second body so as to scrape out contaminants attached at the drain valve passage.

8. The air separator of claim 1, wherein the exterior passage is provided in a direction where the elastic member is disposed.

9. The air separator of claim 1, wherein the piston further comprises a plurality of sealing members fitted respectively in exterior circumferences of the first body and the second body.

10. The air separator of claim 1, further comprising a guide member extending from the first body,
wherein the guide member has a blow hole formed at one side.

11. The air separator of claim 1, further comprising a fixed member covering the elastic member and the guide member and coupled to the drain body.

12. A drain valve apparatus for exhausting a separated liquid including contaminants separated from air in an air separator for cooling and purifying the air, comprising:
a drain body having an interior passage formed at an upper portion of the drain body, a drain valve passage formed to communicate with the interior passage, an air inflow passage formed to communicate with the drain valve passage, and an exterior passage formed to communicate with the drain valve passage at a lower portion of the drain body; and
a drain valve inserted in the drain valve passage, and adapted to selectively communicate the interior passage with the exterior passage,
wherein the drain valve comprises:
a piston having a first body formed to contact an interior circumference of the drain valve passage and disposed in a direction where the exterior passage is provided, a second body formed to contact an interior circumference of the drain valve passage and disposed in a direction where the air inflow passage is provided, a connecting member connecting the first body with the second body, and a guide member extending from the first body and having a blow hole formed at one side;
an elastic member connected to the first body and moving along a length direction of the drain passage; and
a fixed member covering the elastic member and the guide member, and coupled to the drain body.

13. The drain valve apparatus of claim 12, wherein the exterior passage communicates with the drain valve passage apart from the interior passage in a length direction of the drain valve passage.

14. The drain valve apparatus of claim 12, wherein the exterior passage is provided in a direction where the elastic member is disposed.

15. The drain valve apparatus of claim 12, wherein the interior passage is perpendicular to the drain valve passage.
